(19) United States
(12) Patent Application Publication
(10) Pub. No.: US 2016/0308897 A1
(43) Pub. Date: Oct. 20, 2016

(54) System for Analyzing Susceptibility to Social Engineering and Benchmarking Based on Characterization Attribute and Theme

(71) Applicant: Mark T. Chapman, Muskego, WI (US)

(72) Inventor: Mark T. Chapman, Muskego, WI (US)

(73) Assignee: PhishLine, LLC, Waukesha, WI (US)

(21) Appl. No.: 15/098,445

(22) Filed: Apr. 14, 2016

Related U.S. Application Data
(60) Provisional application No. 62/147,414, filed on Apr. 14, 2015.
(60) Provisional application No. 62/185,299, filed on Jun. 26, 2015.

(51) Int. Cl. H04L 29/06; H04L 12/58; H04L 29/08; G06F 17/24; G06F 3/0484

(52) U.S. Cl. CPC H04L 63/1433; H04L 63/1483; G06F 17/248; G06F 3/04842; H04L 63/1408; H04L 67/22; H04L 51/046; G06Q 50/01

(57) ABSTRACT

A system for testing the susceptibility of an organization to social engineering is provided. The system includes an interface configured to receive input from the organization selecting characterization attributes for message templates for a social engineering campaign. The system includes a processor configured to receive the input through the interface. The system generates a message template inventory containing a plurality of message templates from combinations of phishing template patterns, characterization attributes, and themes such that the generated templates include tag content that is consistent. The processor is configured to select message templates from the plurality of message templates consistent with the characterization attributes selected by the organization and to display the number of the selected message templates through the interface to the user.

### CROSS REFERENCE TO RELATED APPLICATIONS

This patent application claims the benefit of U.S. Provisional Patent Application No. 62/147,414, filed Apr. 14, 2015, and U.S. Provisional Patent Application No. 62/185,299, filed Jun. 26, 2015, the entire teachings and disclosures of which are incorporated herein by reference thereto.

### BACKGROUND OF THE INVENTION

The present invention relates generally to susceptibility to social engineering such as phishing and more specifically to systems and software services for testing and/or reducing the susceptibility of an organization to social engineering.

Social engineering includes manipulation, such as psychological manipulation, of people into performing actions or divulging confidential information, for example, information that people would not normally disclose. Such information can be used for various nefarious purposes, e.g., electronic theft, fraud, etc. One form of social engineering is phishing. Phishing is a technique of fraudulently obtaining confidential information. For example, a phisher may send a message, e.g., e-mail, text, SMS, telephone call, voicemail, pre-recorded message, etc., to a recipient. The message may request the recipient to take some action, e.g., click a link, open and/or download a file, provide confidential information, etc. In the case of a link, the link may take the recipient to a website that requests the recipient to provide confidential information on false pretenses. Other links may take the recipient to a website that is designed to download malicious code onto the recipient's electronic device, e.g., code that captures the recipient's personal information from the electronic device, etc. Phishing messages may be designed to be difficult to identify as such, e.g., the messages may be written, include information, etc., to appear to originate from a legitimate source. Additionally, the efficacy of the testing of susceptibility to phishing may be improved by sending different phishing e-mails, e.g., not sending the same phishing e-mail to members of the organization each time the susceptibility to social engineering is to be tested.

### SUMMARY OF THE INVENTION

One embodiment of the invention relates to a system for creating phishing templates to test the susceptibility of an organization to social engineering. The system includes an interface configured to receive at least one of a first input indicative of a characterization attribute and a second input indicative of a theme topic from a user. The system includes a database including a plurality of tags having different characterization attributes and theme topics. The system includes a processor configured to create a phishing template based on a phishing pattern including a plurality of indicators indicative of types of tags to be located in the phishing template. The processor is configured to select tags from the plurality of tags in the database based on the at least one first input indicative of the characterization attribute and the second input indicative of the theme topic received from the user.

Another embodiment of the invention relates to a method of generating phishing templates. The method includes creating a pattern including a first indicator referencing a first type of tag and a second indicator referencing a second type of tag. The method includes receiving an input from a user indicative of a characterization attribute. The method includes providing a database of tags of a first type and tags of a second type. Each tag has a characterization attribute. The method includes generating and storing all combinations of pairs of tags of the first type and tags of the second type. The method includes receiving a request from a user for a phishing template. The request includes a specified characterization attribute. The method includes selecting a pair of tags. The characterization attribute of both the selected first and second tags matches the specified characterization attribute.

Another embodiment of the invention relates to a method of creating phishing templates. The method includes selecting a pattern from a plurality of patterns. The selected pattern includes a plurality of indicators indicating different types of tags. The method includes providing a database including a plurality of different types of tags. Each tag has a characterization attribute. The method includes receiving a selected characterization attribute from a user. The method includes selecting a first tag of a first type indicated by a first one of the plurality of indicators. The first tag has a first characterization attribute compatible with the selected characterization attribute. The method includes selecting a second tag of a second type indicated by a second one of the plurality of indicators. The second tag has a second characterization attribute. The method includes verifying that the second characterization attribute is compatible with the first characterization attribute. The method includes creating a first phishing template including the first tag and the second tag.

Another embodiment of the invention relates to a method of creating phishing templates. The method includes selecting a pattern from a plurality of patterns. The selected pattern includes a plurality of indicators indicating different types of tags. The method includes providing a database including a plurality of different types of tags. Each tag has a characterization attribute and a theme. The method includes receiving a selected characterization attribute and a selected theme from a user. The method includes selecting a first tag of a first type indicated by a first one of the plurality of indicators. The first tag has a first characterization attribute and a first theme. The first characterization attribute is compatible with the selected characterization attribute. The first theme is compatible with the selected theme. The method includes selecting a second tag of a second type indicated by a second one of the plurality of indicators. The second tag has a second characterization attribute and a second theme. The second characterization attribute is compatible with the first characterization attribute. The second theme is compatible with the first theme. The method includes creating a first phishing template including the first tag and the second tag.

Another embodiment of the invention relates to a system for testing the susceptibility of an organization to social engineering. The system includes an interface. The interface is configured to receive input from the organization selecting characterization attributes for message templates for a social engineering testing campaign. The system includes a processor. The processor is configured to receive the input through the interface. The system includes a message template inventory containing a plurality of message templates. Each of the templates has characterization attributes. The processor is configured to select message templates from the plurality of message templates consistent with the characterization attributes selected by the organization. The system is configured to display the number of the selected message templates through the interface to the user.

Another embodiment of the invention relates to a method of testing susceptibility of an organization to social engineering. The method includes compiling projected engagement rate statistics for message templates based on characterization attributes. The method includes displaying projected engagement rate statistics for messages based on characterization attributes. The method includes receiving desired characterization attributes from a social engineering testing campaign from the organization. The method includes selecting message templates from a message template inventory based on received desired characterization attributes. The method includes producing phishing messages based on the selected message templates. The method includes sending the phishing messages to members of the organization. The method includes monitoring actual engagement rate for the phishing messages sent to the members of the organization. The method includes displaying the actual engagement rate to the organization.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a phishing e-mail template according to an exemplary embodiment.

FIG. 2 is a phishing e-mail pattern according to an exemplary embodiment.

FIG. 3 is a first phishing e-mail template created based on the phishing e-mail pattern of FIG. 2 according to an exemplary embodiment.

FIG. 4 is a second phishing e-mail template created based on the phishing e-mail pattern of FIG. 2 according to an exemplary embodiment.

FIG. 5 is a system for generating a plurality of e-mails having different characteristics shown schematically according to an exemplary embodiment.

FIG. 6 is the campaign profile indicator look up table of FIG. 5 according to an exemplary embodiment.

FIG. 7 is a graph of a library of phishing templates according to an exemplary embodiment.

FIG. 8 is a block diagram illustrating a system for analyzing susceptibility to social engineering and benchmarking or collecting statistics regarding message template effectiveness according to an exemplary embodiment.

FIG. 9 illustrates a graphical user interface configured to receive input from an organization indicating preferences for message templates to be used for a social engineering testing campaign according to an exemplary embodiment.

FIG. 10 illustrates a graphical user interface showing projected engagement rates and inventory for characterization attributes and theme topics according to an exemplary embodiment.

FIG. 11 illustrates a graphical user interface showing projected engagement rates based on characterization attributes according to an exemplary embodiment.

### DETAILED DESCRIPTION

Referring generally to the figures, one way that an organization's susceptibility to social engineering can be improved is through simulations in which communications are sent to members of the organization. The communications are fake malicious communications, e.g., “phishes,” intended to test the recipient member of the organization for susceptibility to actual social engineering attacks.

Various different types of communications or phishes may be sent to members of the organization over various communication mediums. The phish communications solicit the recipients to respond. Responses solicited may be over various communication mediums, e.g., the same medium as the phish communications, a different medium than the phish, etc. For example, in one embodiment, a phish communication may be sent to a recipient member of the organization via e-mail, e.g., SMTP, etc. In another embodiment, a phish communication may be sent via text message, e.g., SMS, etc. In another embodiment, a phish communication may be sent via an audible message, e.g., telephone call, voicemail, etc. In another embodiment, a phish communication may be sent via social media message, e.g., Twitter message, Facebook message, etc. In another embodiment, a phish communication may be a printed document. In one embodiment, the phish communication may solicit a response via an e-mail. In another embodiment, the phish communication may solicit a response via a text message. In another embodiment, a phish communication may solicit a response via a telephone call. In another embodiment, a phish communication may solicit a response via a social media message. In another embodiment, a phish communication may solicit the recipient to visit a webpage, for example, to provide information such as confidential information, to the webpage.

Many organizations have many different members that will respond differently depending on the nature of the communication that each member receives. Additionally, different members will respond to communications differently depending on the time, e.g., relative to other events, that the communication is received by each member. Therefore, it may be advantageous to create different communications to be sent to members of the organization and to personalize each of those messages with information specific to each of the recipients. Additionally, tests may be improved by sending multiple phish communications to members of the organization. However, sending the same, or a similar, similarly themed, etc., phish communication to all of the members may reduce the effectiveness of the testing, e.g., a member that views the phish communication first may inform other members of the organization that the communication is a phishing communication, once a member of the organization has received a phishing communication once, the member is unlikely to fall for the exact same or similar phishing communication again, etc. Additionally, testing may also include sending more than one round of phish communications to the members of the organization. Therefore, it may be beneficial to generate multiple different, differently themed, differently characterized, etc., phishing communications.

In one embodiment, to prepare phishing communications for multiple members of an organization, a communication template is created. A template may be used, for example, by a processor such as an e-mail generator to create personalized phish communications to be sent to various members of an organization. The template includes personal information indicators. The indicators indicate the type of personal information to be included in the communication created based on the template and where to locate the personal information in the template. The personal information may be obtained, for example, from a database of information regarding the members of the organization.

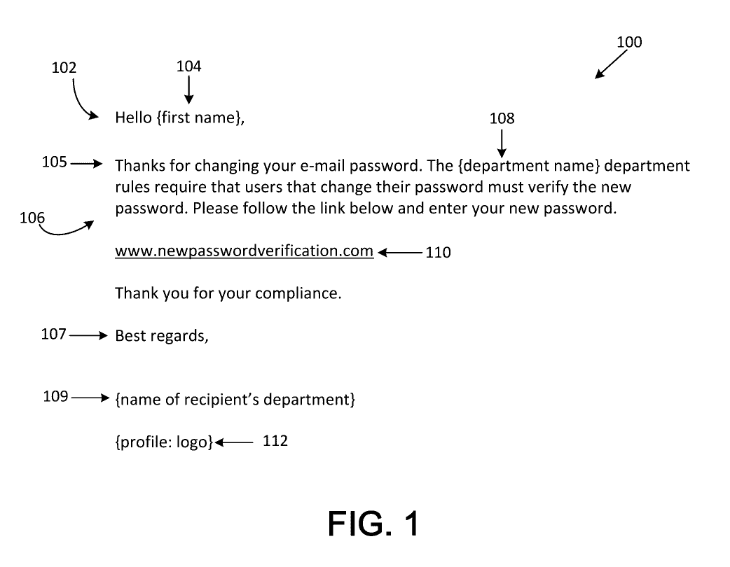

For example, an embodiment of a template, shown as an e-mail template 100, is illustrated in FIG. 1. The e-mail template 100 includes various different types of portions of information content, e.g., salutation 102, pretext portion 105, call to action portion 106, closing portion 107, etc., as will be further described below.

In one embodiment, the e-mail template 100 includes a salutation 102. The salutation 102 includes a name indicator 104. The name indicator 104 indicates to the e-mail generator that when an e-mail communication is created based on the e-mail template 100 what portion of the name of the intended recipient should be added to the e-mail in the salutation. The e-mail template 100 also includes a pretext portion 105 to be added to the e-mail generated from the e-mail template at the indicated location, e.g., in one embodiment including a reason that the recipient is receiving the e-mail. The e-mail template 100 also includes a call to action portion 106. The call to action portion 106 indicates a call to action to be added to the e-mail created by the e-mail generator from the template soliciting the recipient to take an action, in the illustrated embodiment soliciting the recipient to confirm a new password. The e-mail template 100 also includes a closing portion 107, such as a closing that may be used to conclude an e-mail. The call to action portion 106 includes a department name indicator 108. The department name indicator 108 indicates to the e-mail generator that when an e-mail is created based on the e-mail template 100 that the name of the recipient's department within the organization will be included in the e-mail at the location indicated by the department name indicator 108. The e-mail template 100 also includes a signature portion 109. The signature portion 109 indicates to the e-mail generator what information should be included in the signature, for example, in the illustrated embodiment, the signature portion 109 indicates that the signature in the generated e-mail should be the name of the recipient's department, which may be obtained by the e-mail generator for example, from an address book, company database, etc. The e-mail template 100 also includes a link 110. The link 110 links to a webpage that will solicit the recipient of the e-mail to enter the recipient's new password. In one embodiment, the e-mail generator is configured to customize the link in each generated e-mail such that when the link is clicked by a recipient, the recipient that clicked the link can be identified. Additionally, the e-mail template 100 includes a logo indicator 112. The logo indicator 112 is configured to indicate to the e-mail generator to include the logo 112 of an organization, such as the organization of the intended recipient, other recognizable and/or reputable organization, etc., in an e-mail generated from the template 100, which may tend to convince the recipient of the credibility of the e-mail.

However, if a single template is used to create the phishing messages to be sent to all of the members of the organization, if one member finds out first that the message is a phishing message, that member may inform the other members that that particular message is a phishing message, which may reduce the efficacy of the testing.

Therefore, it may be advantageous to create various different templates, e.g., different types, different themes, different characteristics, etc., such as the e-mail template 100 illustrated in FIG. 1. For example, effectiveness of social engineering testing and susceptibility reduction may be improved by creating many different types of e-mail templates. Additionally, effectiveness of social engineering testing and susceptibility reduction may be improved by varying characteristics of the different portions of the template, including varying the characteristics relative to the other portions of each template.

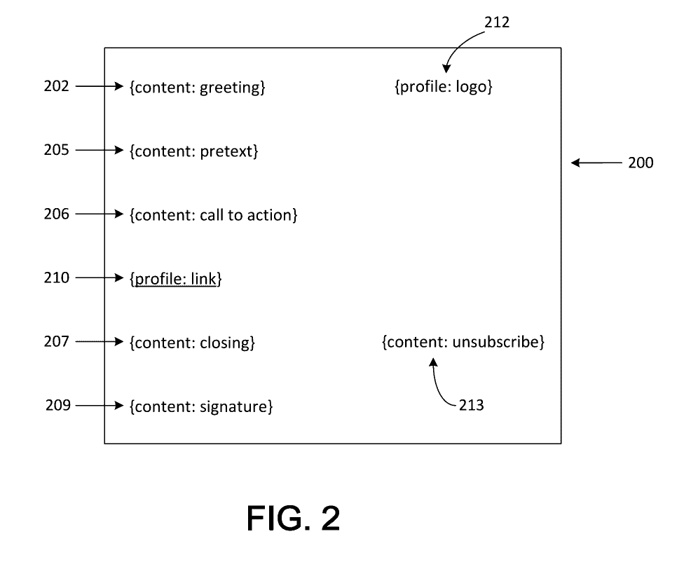

In one embodiment, meta-templates such as phishing patterns may be used by a processor to create multiple different templates, e.g., with different themes, characteristics, etc. With reference to FIG. 2, an embodiment of a meta-template shown as an e-mail phishing pattern 200 is illustrated. The e-mail phishing pattern 200 is configured to be used, for example, by a processor, to create multiple different e-mail templates, e.g., with different themes, characteristics, etc., including an e-mail template 100 as shown in FIG. 1. In one embodiment, the e-mail phishing pattern 200 combines a what you see is what you get or text-only design with indicators. The e-mail phishing pattern 200 includes a content greeting indicator 202. The content greeting indicator 202 is configured to trigger the processor to include a greeting tag in the e-mail template created based on the e-mail phishing pattern 200 at the indicated location, as will be further described below. The e-mail phishing pattern 200 includes a content pretext indicator 205. The content pretext indicator 205 is configured to trigger the processor to include a pretext tag in an e-mail template being created by the processor in the indicated location. The e-mail phishing pattern 200 also includes a content call to action indicator 206. The content call to action indicator 206 is configured to trigger the processor to include a call to action tag in an e-mail template being created by the processor in the indicated location. The e-mail phishing pattern 200 also includes a content closing indicator 207. The content closing indicator 207 is configured to trigger the processor to include a closing tag in an e-mail template being created by the processor in the indicated location. The e-mail phishing pattern 200 also includes a content signature indicator 209. The content signature indicator 209 is configured to trigger the processor to include a signature tag in an e-mail template being created by the processor in the indicated location. The e-mail phishing pattern 200 also includes a profile link indicator 210. The profile link indicator 210 is configured to be replicated by the processor in an e-mail template being created by the processor in the indicated location and also to indicate to the e-mail generator generating a phishing e-mail based on the template to include a link to a webpage, e.g., a link from which the system can identify what member of the organization clicked on the link, in phishing e-mails created in the indicated location. The e-mail phishing pattern 200 also includes a profile logo indicator 212. The profile logo indicator 212 is configured to be replicated by the processor in an e-mail template being created by the processor and also to indicate to the e-mail generator generating a phishing e-mail based on the template to include a logo in the phishing e-mail in the indicated location. The e-mail phishing pattern 200 also includes a content unsubscribe tag 213. The content unsubscribe tag 213 is configured to trigger the processor to include a portion, for example, a clickable portion, to allow a recipient of an e-mail created based on the e-mail template to attempt to unsubscribe from receiving the e-mail. In one embodiment, the clickable portion is not functional, e.g., does not allow the recipient to unsubscribe from receiving further test phishing e-mails.

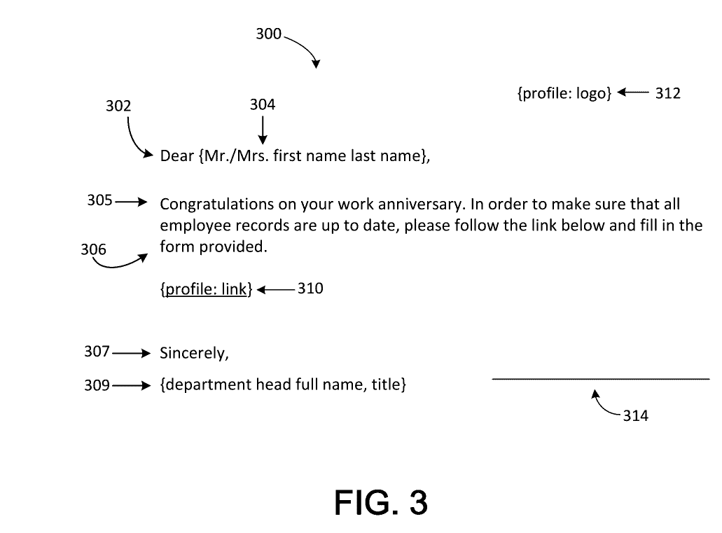

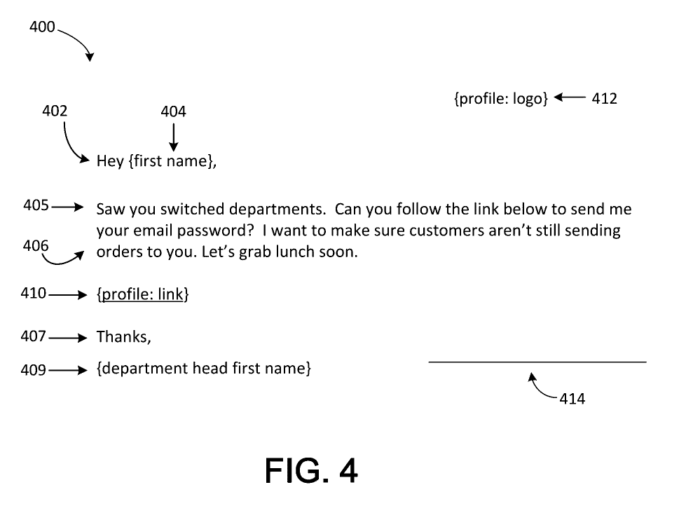

The processor can create various different e-mail templates with various different characteristics, themes, etc., based on the e-mail phishing pattern 200. For example, embodiments of e-mail templates 300 and 400 are illustrated in FIGS. 3 and 4. Each of the e-mail templates 300 and 400 includes a salutation tag 302 and 402 and a name identifier 304 and 404. However, the salutation tag 302 and name identifier 304 in e-mail template 300, Dear {Mr./Mrs. first name last name}, have different characteristics, a different level of formality, familiarity, etc., than the salutation tag 402 and name identifier 404 in the e-mail template 400, Hey {first name}. Additionally, each e-mail template 300 and 400 includes a pretext tag 305 and 405. However, the pretext tags 305 and 405 have different characteristics, a different level of formality, familiarity, etc. Each of e-mail templates 300 and 400 include a call to action tag 306 and 406 with each call to action portion having different characteristics, a different level of formality, familiarity, etc. Each of the e-mail templates 300 and 400 include a closing tag 307 and 407 with each closing tag 307 and 407 having different characteristics, a different level of formality, familiarity, etc. Each of the e-mail templates 300 and 400 includes a signature tag 309 and 409 with each signature tag 309 and 409 having different characteristics, a different level of formality, familiarity, etc. The salutation tag 302, the name identifier 304, the pretext tag 305, the call to action tag 306, the closing tag 307, and the signature tag 309 all have similar characteristics, similar level of formality, familiarity, etc., such that the e-mail template 300 overall can be used by an e-mail generator to produce an e-mail that has a consistent feel throughout. Similarly, the salutation tag 402, the name identifier 404, the pretext tag 405, the call to action tag 406, the closing tag 407, and the signature tag 409 all have similar characteristics, similar level of formality, familiarity, etc., such that the e-mail template 400 overall can be used by an e-mail generator to produce an e-mail that has a consistent feel throughout.

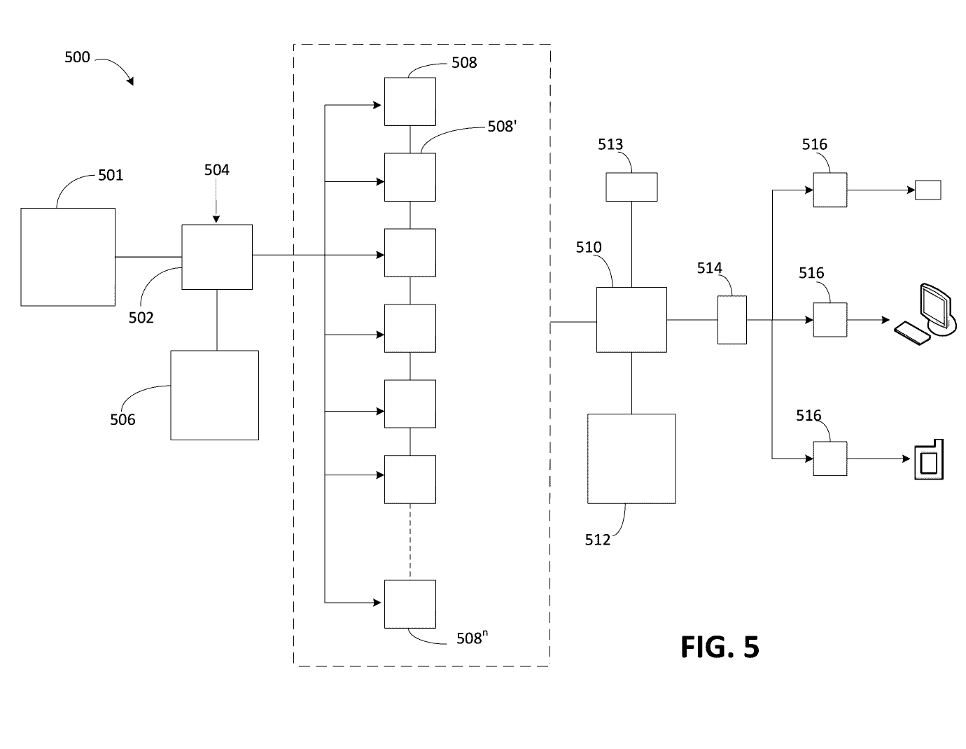

With reference to FIG. 5, an embodiment of a system 500 for generating a plurality of e-mails having different characteristics is illustrated. A phishing pattern 501, similar to the pattern 200 illustrated in FIG. 2, including a plurality of indicators is provided. A processor 502 receives input 504 from a user. In one embodiment, the input 504 includes theme information for phish communications to be created, e.g., subject matter information for phish communications. In one embodiment, the processor 502 provides an interface to the user through which the processor 502 is configured to receive the input information 504 from the user. The interface provides a multi-level list of possible themes organized, for example, in a tree structure of drop down menu lists, e.g., a top level theme cluster, a next level theme group, and a final level theme topic. For example, the theme clusters may include commerce, company internal, financial, personal, social, technology, etc. The theme group level may include, for example, announcements, automotive, back to school, banking/credit card, building security, business networking, bring your own device, chain letter, charity/causes, etc. The theme topic level may include, for example, account cancellation, account compromised, account overdraft, account verification, address change, affordable care act enrollment, accept your friend request, 1099 now available, etc.

In one embodiment, the input 504 also includes characterization information for phish communications to be created, e.g., information regarding the way information will be presented in the phishing communication. The interface provides a multi-level list of possible characterization information for phish communications organized, for example, in a tree structure of drop down menu lists, radio buttons, etc. In one embodiment, characterization attributes represent multiple options within a characterization category. In one embodiment, they are assigned a numeric value, such as on a scale of 1 to 3, 1 to 5, 1 to 20, 1 to 50, etc. For other characterization attributes, such as “Language”, the attributes would simply be a list of languages, regions, etc. In one embodiment, the characterization interface includes top level characterization categories describing the level of sophistication and ease of recognition of attributes. In one embodiment, the characterization categories include relevance (relevance of the message to the target user/organization), design (level of sophistication for the visual design and layout of the message), branding (the extent to which third party brands and trademarks may be incorporated into the message), internal (the extent to which valid internal entities may be incorporated into the message), formality (level of formality for the message), language (the natural language for the message), personalization (level of personalization for the message), grammar correctness (the level of correct use of grammar and punctuation), spelling or typos (level of spelling errors or other typos), etc. The characterization interface also includes a second level of characterization attribute choices.

In one embodiment, when the user selects the branding category, multiple levels of available branding are presented to the user for selection of a branding level by the user. For example, the interface may present the user with the option to select branding level 1 (message does not knowingly reference or emulate known third-party brands), branding level 2 (message emulates a brand without using the actual brand name), or branding level 3 (message uses actual brand name or mark). In other embodiments, other suitable levels or numbers of levels may be used.

In one embodiment, when the user selects the design category, multiple levels of available design are presented to the user for selection of a design level by the user. For example, the interface may present the user with the option to select design level 1 (message includes plain text with negligible use of images), design level 2, (message includes formatted text, possibly in multiple columns, and related images), or design level 3 (message includes highly formatted output that looks polished with integrated graphics and layout). In other embodiments, other suitable levels or numbers of levels may be used.

In one embodiment, when the user selects the formality category, multiple levels of available formality are presented to the user for selection of a design level by the user. For example, the interface may present the user with the option to select formality level 1 (message includes information words, colloquial language, slang, abbreviations borrowed from texting, etc.), formality level 2 (normal business language), or formality level 3 (strict use of formal language style including, for example, technical language such as language common to the medical field, legal field, insurance field, etc.). In other embodiments, other suitable levels or numbers of levels may be used.

In one embodiment, when the user selects the internal category, multiple levels of available internal reference levels are presented to the user for selection of an internal reference level by the user. For example, the interface may present the user with the option to select internal level 1 (message contains no reference to real departments, divisions, or people in the target organization), internal level 2 (message contains generic names of internal entities without using organization-specific reference, e.g., human resources, IT, etc.), or internal level 3 (message contains actual names of entities or people within the target organization). In other embodiments, other suitable levels or numbers of levels may be used.

In one embodiment, when the user selects the language category, a variety of language choices in which the message may be written (e.g., English, Spanish, Greek, Swahili, etc.). In other embodiments, other suitable languages in which the message may be written may be provided.

In one embodiment, when the user selects the personalization category, multiple levels of personalization are presented to the user for selection of a personalization level by the user. For example, the interface may present the user with the option to select personalization level 1 (message does not use any personal information beyond e-mail address or similar), personalization level 2 (message contains some personal information such as first or last name), personalization level 3 (message contains highly targeted personal information that goes beyond level 2 including, for example, other attributes that are specific to the intended recipient such as department, number of years at the company, etc.). In other embodiments, other suitable numbers of personalization levels in which the message may be written may be provided.

In one embodiment, when the user selects the relevance category, multiple levels of relevance are presented to the user for selection of a relevance level by the user. For example, the interface may present the user with the option to select relevance level 1 (message content is random, irrelevant, general, etc.), relevance level 2 (message content is somewhat compelling, somewhat relevant, and somewhat believable), or relevance level 3 (message content is compelling, relevant, timely, targeted, and plausible). In other embodiments, other suitable languages in which the message may be written may be provided.

Users may provide input for desired characterization attributes and levels of characterization attributes for one or more than one available characterization attribute category.

The processor 502 is in communication with and/or has access to a database 506. The database 506 includes salutation tags, pretext tags, call to action tags, closing tags, and signature tags which can be used to create a phishing template based on a phishing pattern. The salutation tags, pretext tags, call to action tags, closing tags, and signature tags are categorized by characterization attributes and theme topics. Based on the indicators included in the pattern 501 and the characterization attributes and theme topics selected by the user, the processor 502 can select salutation tags, pretext tags, call to action tags, closing tags, and signature tags from the database 506 and create a plurality of different phishing templates 508, 508′, . . . 508ⁿ.

In one embodiment, for phishing patterns that include a link, e.g., a link to a webpage, in a phishing template created based on the phishing pattern, the processor 502 is configured to create a webpage for the link. The processor 502 is configured to create the webpage to be consistent with the characterization attributes, theme topics, branding, and/or campaign profile, selected for the phishing template including the link configured to link to the created webpage.

In one embodiment, the system 500 includes a spelling wrecker module and a spelling wrecker database. The spelling wrecker database includes a plurality of words and misspellings of those words. The spelling wrecker module is configured to search phishing templates and to replace some of the words in the templates found in the spelling wrecker database with misspellings of those words. In another embodiment, a spelling wrecker module is provided. The spelling wrecker module is configured to randomly add or delete letters to one of the templates to create spelling errors in the template. In another embodiment, the spelling wrecker module is configured to introduce spelling errors into phishing messages created based on phishing templates.

In one embodiment, the system 500 includes a grammar wrecker module and a grammar wrecker database. The grammar wrecker database includes groups of words, e.g., common groups of words, and these groups of words with grammar errors introduced. In one embodiment, the groups of grammar errors introduced are classified in the grammar wrecker database by the types of grammar errors that the errors are, e.g., subject-verb number disagreement, common grammar errors for non-native speakers, etc. The grammar wrecker module is configured to search the templates, or phishing messages created from the templates, to find groups of words matching groups of words in the grammar wrecker database and to replace them with the groups of words with grammar errors introduced to introduce grammar errors into the templates, or phishing messages.

In one embodiment, the system 500 is configured to receive input from a user indicating whether to introduce spelling errors and/or grammar errors, the level, e.g., how many spelling errors and/or grammar errors to introduce, the type of spelling and/or grammar errors to introduce, etc.

In one embodiment, the system 500 includes a wrecker protector module. The wrecker protector module includes a wrecker protector database including a plurality of words, phrases, numbers, etc., that may be perceived as vulgar, offensive, etc. The wrecker protector module is configured to review the portions of the templates or phishing messages modified to include spelling or grammar errors by the spelling wrecker module and/or grammar wrecker module to determine whether any of the words, phrases, numbers, etc., in the wrecker protector database that may be perceived as vulgar, offensive, etc., are included in the template or phishing message as a result of the spelling or grammar wrecker changes. If any of these words, phrases, numbers, etc., are included, the wrecker protector module is configured to undo the change of the spelling or grammar wrecker module, to direct the spelling or grammar wrecker module to make a new change to the template or message, and to verify that the new change does not result in a word, phrase, number, etc., that is included in the wrecker protector database.

In one embodiment, the system 500 includes a phishing message generator 510. The phishing message generator 510 has access to information regarding members of an organization, in the illustrated embodiment an organization address book, including personal information (e.g., name, department, number of years of service with the company, title within the company, etc.) and contact information (e.g., e-mail address, mobile telephone number, social media contact information, etc.) of members of the organization. The phishing message generator 510 also has access to campaign profile information, shown as a campaign profile indicator look up table 513.

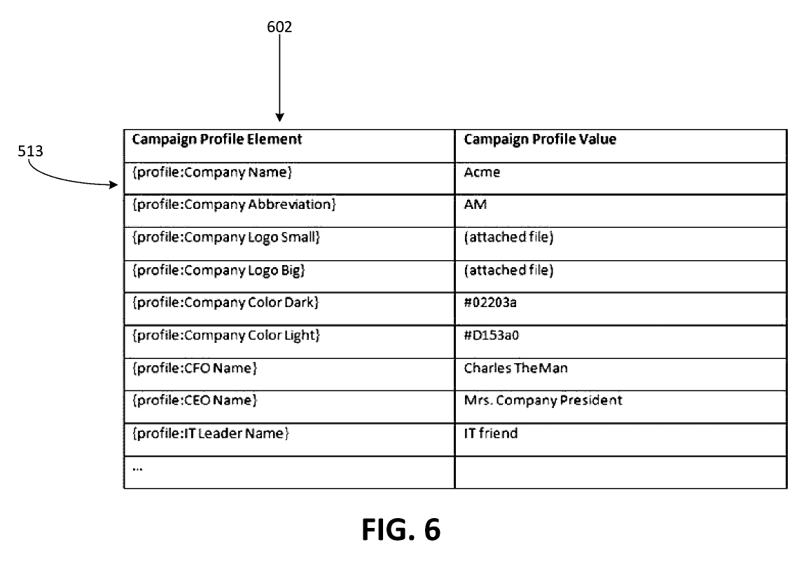

With reference to FIG. 6, in one embodiment, the campaign profile indicator look up table 513 includes a plurality of profile indicators 602 that may be included in the phishing templates 508 and values to be included in phishing messages generated by the phishing message generator 510 at the locations indicated by the profile indicators 602. Thus, the same e-mail templates may be used for different organizations. For example, a first organization may provide a first campaign profile that defines the company name value in the campaign profile indicator look up table 513 to be Acme, the company CFO name to be Charles TheMan, and the company CEO name to be Mrs. Company President. A second organization may define the company name value in a second campaign profiling indicator lookup table to Beta, the company CFO name to be Mary TheWoman, and the company CEO name to be Mr. Company President. The phishing message generator 510 when generating messages for the first organization and encountering a profile indicator 602 in a template 508 may access the look up table 513 to include a corresponding value in the phishing message generated at the location indicated by the indicator. The phishing message generator 510 when generating messages for the second organization and encountering a profile indicator in a template 508 may access the second look up table to include a corresponding value in the phishing message generated. Additionally, multiple other profile indicator look up tables may be generated to include information, logos, etc., of fanciful, e.g., non-existent, companies, such that phishing messages appearing to originate from various organizations outside of the organization which is being tested for susceptibility to phishing attacks may be generated.

With further reference to FIG. 5, in one embodiment, when a phishing campaign to test the susceptibility of an organization to social engineering is requested, the phishing message generator 510 receives information regarding the type of phishing messages, e.g., the medium over which the phishing messages will be delivered, to be generated. The phishing message generator 510 selects a template 508. The phishing message generator 510, based on indicators, e.g., name indicator 102, department name indicator 108 (see FIG. 1) in the template 508 creates a phishing message 514 including personal information regarding the intended recipient from the address book 512, locating the personal information at locations in the message indicated by the e-mail template 508. The phishing message generator 514 also includes campaign profile values in the phishing message 514 at locations indicated by the profile indicators in the phishing template 508 based on the information in the campaign profile indicator look up table 513, e.g., includes the company name, logo, etc., in the phishing message 514. Then, based on the type of phishing message, the phishing message generator 514 forwards the phishing message 514 to a message server 516 for delivery to the intended recipient. The phishing message generator 514 includes delivery or contact information for the intended recipient from the address book 512 such that the phishing message 514 can be delivered to the intended recipient. For example, if the phishing message 514 is an e-mail message, the phishing message 514 is forwarded to an e-mail server, if the phishing message 514 is a text message, the phishing message 514 is forwarded to a text message server, if the phishing message 514 is an audible message, the phishing message 514 is forwarded to an audible message server (e.g., text-to-voice translator, etc.), if the phishing message 514 is a physical printed message, the phishing message 514 is forwarded to a physical printed message server (e.g., organization mail room, post office, etc.), etc.

In one embodiment, the system 500 is configured to store, e.g., in a memory, database, etc., information regarding the characterization attributes and theme topics of each of the phishing messages 514 sent, for example, in a campaign. The information regarding the characterization attributes and theme topics can be determined from the phishing template 508 used by the phishing message generator 510, as the phishing message generator 510 is configured to produce a phishing message 514 that has the same characterization attributes and theme topics as the phishing template 508 from which it is produced. The phishing messages 514 request that the recipient take some action, e.g., click a link, respond to the message, provide confidential information, etc. The system 500 is configured to determine whether each phishing message 514 was a success, e.g., the recipient took the action requested by the phishing message, or a failure, e.g., the recipient did not take the action requested by the phishing message. Additionally, in one embodiment, the system 500 is configured to determine what action specifically was taken by the recipient, e.g., what confidential information was provided, etc.

Based on the success/failure results and characterization attributes and theme topics of the phishing messages (e.g., the phishing templates from which the phishing messages were created), the system 500 is able to conduct analysis, e.g., benchmarking analysis, and to report and analyze results based on the characterization attributes and theme topics. For example, the system 500 may determine that recipients take the action requested by the phishing message x % of the time if the phishing message received by the recipient has a business theme topic and includes spelling errors, but recipients take the action requested by the phishing message y % of the time if the phishing message received by the recipient has a business theme topic and does not include spelling errors. In one embodiment, analysis of organizational performance in social engineering susceptibility testing relative to characterization attributes and theme topics can be compared to historical organization performance, industry performance, other performance benchmarks, etc.

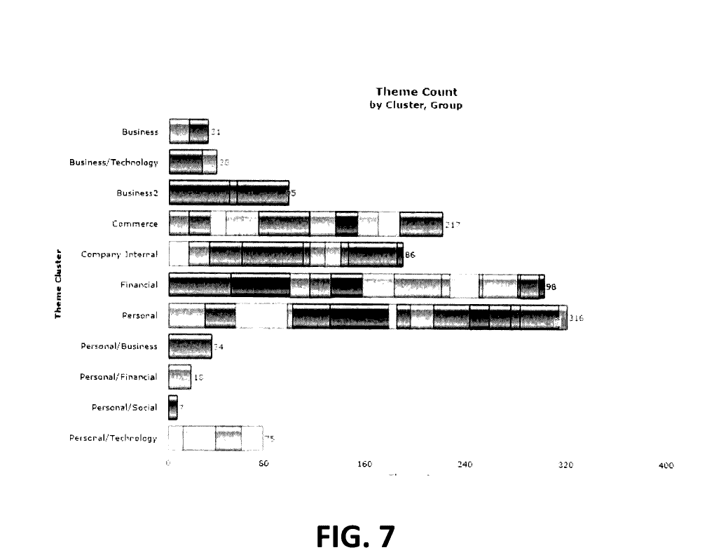

In one embodiment, the system 500 is configured to inventory the library or a subset of the library of phishing templates 508, 508′, . . . 508ⁿ that are available. FIG. 7 shows an exemplary graph illustrating numbers of available phishing templates arranged by theme cluster and showing number of theme groups in each theme cluster and number of theme topics in each theme group.

In one embodiment, a system for creating phishing templates includes an interface, e.g., including a graphical user interface, configured to receive input from a user to create tags, e.g., a library of tags to be used in creating templates. The interface is configured to receive tags from a user and an input from a user to indicate the type of each tag that the user inputs, e.g., the indicator in a phishing pattern that will indicate the input tag. For example, the user can enter “Dear Personal Title Lastname Suffix” and indicate that this tag is a “Greeting” tag, e.g., a tag to be used when an indicator in a phishing pattern indicates that a Greeting tag is to be included in the phishing template created based on the phishing pattern. The interface is also configured to receive input from the user regarding whether the input tag is specific to a particular theme (and if so, to which theme the input tag is specific) or whether the tag is generic to all the themes, e.g., can be used in a phishing template regardless of the theme topic selected by the user. Additionally, the interface is configured to receive characterization attribute information for each entered tag. Characterization attribute levels may be rated in various different ways. In one embodiment, levels may be rated numerically. For example, for the Greeting tag described as input above, “Dear Personal Title Lastname Suffix”, a user may specify that this tag has a formality level of 1. Thus, this tag may be included in a phishing template for which a formality characterization attribute of 1 has been specified. Additionally, in one embodiment, the tag may be indicated by a user to satisfy multiple levels for various characterization attributes. For example, the user may indicate that “Dear Personal Title Lastname Suffix” is compatible with a personalization level of both 1 and 2. Thus, this tag may be included in a phishing template for which either a personalization characterization attribute of 1 or a personalization characterization attribute of 2 has been specified. Additionally, in one embodiment, the tag may be indicated by a user to be characterization attribute neutral. For example, the user may indicate that “Dear Personal Title Lastname Suffix” is compatible with all branding levels. Thus, this tag may be included in a phishing template for which any branding characterization attribute has been specified.

In one embodiment, when a user requests that a phishing campaign be generated and selects, at least one phishing pattern, and selects characterization attributes and theme topics for the campaign (in one embodiment, the user may select at least one phishing pattern and not select any characterization attributes and theme topics), the processor 502 (see FIG. 5) will select a first tag from a library of tags, the first tag being of the type, e.g., salutation, call to action, etc., indicated by the first indicator in the phishing pattern. For various characterization attributes, the user may not have entered a desired level. For example, a user may not have indicated a formality level desired. Thus, when a first e-mail template is being created, a tag, compatible with the other characterization attributes and theme topics selected by the user, but with any formality level may be selected from the library of tags. For the first template, once the first tag is selected, the processor 502 is configured to determine the formality level of the first tag and for other tags to be included in the first template, the processor 502 only selects tags that are compatible with the formality level of the first tag. Thus, the processor 502 assures that characterization attributes are consistent throughout the first template. Then, when a second template is created, the processor 502 again selects a new first tag for the second template and can select a tag with any formality level. However, once the new first tag for the second template is selected, the processor 502 assures that only tags with a formality level compatible with the formality level of the new first tag are included in the second template to assure that characterization attributes are consistent throughout the second template, e.g., even for characterization attributes not specified by the user.

In one embodiment, a characterization attribute is consistent if the level of the characterization attribute for a tag is at least as high as the specified characterization attribute level (e.g., a formality level of 1 is consistent with a specified formality level of 5, 4, 3, 2, or 1). In another embodiment, a characterization attribute is consistent if the level of the characterization attribute is equal to the specified characterization attribute level (e.g., a formality level of 2 is consistent with a specified formality level of 2 but is not consistent with a specified formality level of 3). In still another embodiment, a characterization attribute is consistent if the level of the characterization attribute is within a range of the specified characterization attribute level (e.g., specified formality level 3 and a range parameter of 1 is consistent with formality levels 2 and 4, but not formality levels 1 and 5).

In another embodiment suitable for unordered characterization attributes, consistency of characterization attributes may be determined by defined relationships between the attributes. For example, a language attribute of “English” may be defined as consistent only with “English—U.S.”, or with “English—U.S.”, “English—U.K”, and “English—Canadian”. In both examples, the “English” characterization attribute would be defined as incompatible with “French” (all types), “Spanish” (all types), etc.

In one embodiment, a system for creating phishing templates includes an interface, e.g., a graphical user interface. The interface allows the user to select a desired phishing pattern and desired characterization attributes and theme topics. As each combination of characterization attributes and theme topics is selected by the user, the interface is configured to indicate to the user the number of possible e-mail templates satisfying the selected characterization attributes and theme topics based on the currently available library of tags.

Additionally, in one embodiment, the interface is configured to receive from the user campaign profile values (see FIG. 6). Different campaign profile values can be entered to create different campaign profiles, e.g., differently branded campaign profiles. The interface allows the user to select a campaign profile from the available campaign profiles to brand a phishing campaign.

In one embodiment, when a user requests a phishing campaign, selects characterization attributes and theme topics, and designates members of the organization to receive phishing messages, the system is configured to generate a different phishing template for each member of the organization such that each member of the organization receives a unique phishing message, with each phishing message having internal characterization attribute consistency. In one embodiment, when the system determines that a member of an organization has taken an action requested by a phishing message, the system is configured to send the member of the organization suggestions for different types of training to reduce susceptibility to social engineering based on the characterization attributes and/or theme topics of the phishing message sent to the member. The system is also configured to examine future performance by the member in social engineering susceptibility testing and to determine effectiveness of different types of training, etc. In another embodiment, the system 500 (see FIG. 5) is configured to generate a large number, e.g., millions, tens of millions, hundreds of millions, billions, tens of billions, hundreds of billions, etc., of unique phishing messages, e.g., e-mail messages. These e-mail messages can be used to test spam filters to determine if spam filters are susceptible to e-mail messages having particular characterization attributes, theme topics, words, etc. Based on these results, the spam filtering algorithms can be adjusted to improve spam filter performance.

In another embodiment, a plurality of different message templates, such as e-mail template 100 (see FIG. 1), may be created by a user manually, e.g., a user comes up with a salutation word or words and enters them into a computer, selects a location for name indicators, writes a call to action, comes up with a closing word or words, etc. These plurality of message templates form an inventory of templates. In one embodiment, a system for analyzing susceptibility to social engineering is configured to analyze and categorize each of the message templates based on characterization attributes and theme topics. For example, the system is configured to determine the formality level from among a plurality of different formality levels that each template should be assigned, e.g., based on the diction of each template, the name indicators used, such as first name and last name, whether an honorific precedes the name indicator, etc. The system also may be configured to determine relevance (relevance of the message to the target user/organization), design (level of sophistication for the visual design and layout of the message), branding (the extent to which third party brands and trademarks may be incorporated into the message), internal (the extent to which valid internal entities may be incorporated into the message), formality (level of formality for the message), language (the natural language for the message), personalization (level of personalization for the message), grammar correctness (the level of correct use of grammar and punctuation), spelling or typos (level of spelling errors or other typos), etc.

Additionally, in one embodiment, the system is configured to analyze and categorize each of the message templates in the inventory of templates based theme topic, e.g., based on the subject matter of each message template to categorize each message template into subject matter categories, for example, categories from a predetermined list of possible categories.

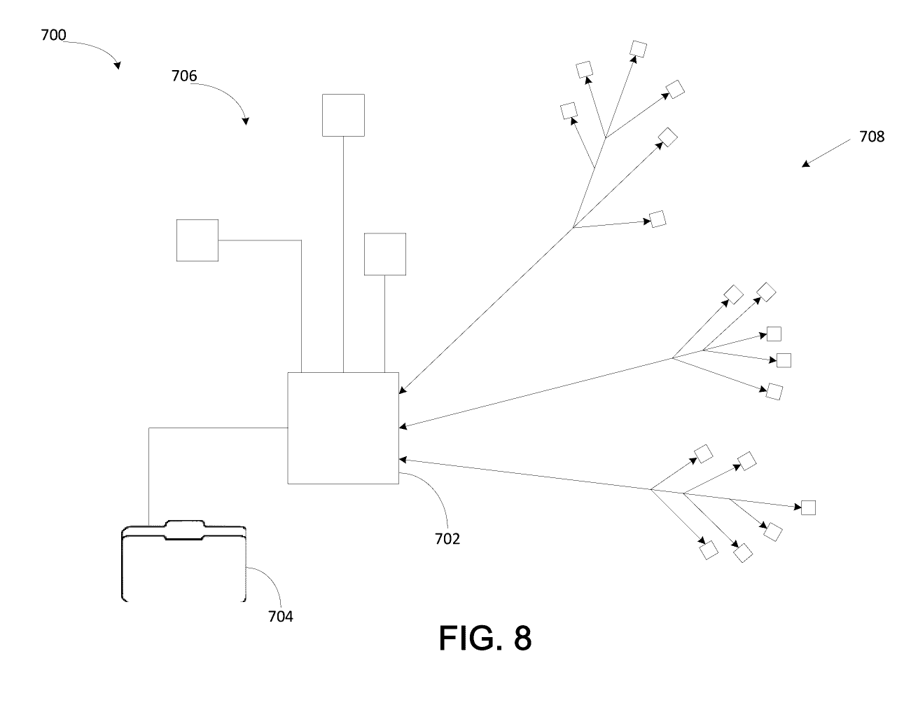

With reference to FIG. 8, an embodiment of a system 700 for analyzing susceptibility to social engineering and benchmarking or collecting statistics regarding message template effectiveness is illustrated. The system 700 includes a processor 702 and an inventory of message templates 704. The message templates 704 each have information regarding their characterization attributes and theme topics, either because the message templates 704 were generated from a pattern 200, as described above, or because hand generated message templates 704 have been analyzed to determine their characterization attributes and theme topics, as described above. The processor 702 is configured to receive inputs from a plurality of organizations 706 through interfaces. In one embodiment, the organizations 706 each select a message template from the inventory to be used to generate messages to members of that organization. In another embodiment, the organizations 706 select desired characterization attributes and theme topics based on which message templates matching the selected characterization attributes and theme topics may be selected by the processor 702 from the inventory 704.

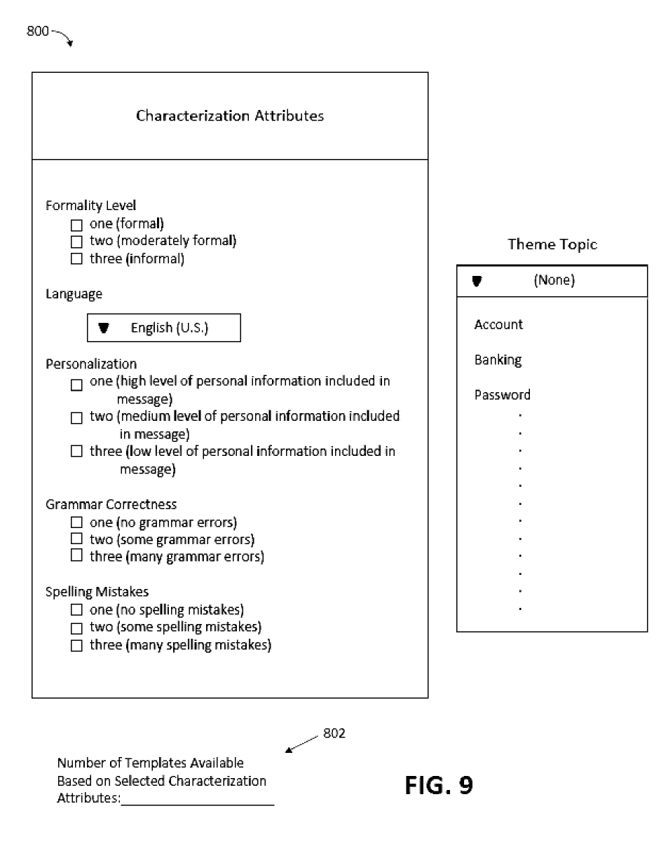

With reference to FIG. 9, an embodiment of a graphical user interface 800 through which organizations can input information regarding message templates to be used for a social engineering testing campaign is illustrated. The interface 800 includes a characterization attributes portion in which a user can select, e.g., using radio buttons, drop down menus, etc., different characterization attributes for messages to be used in a social engineering testing campaign. The interface 800 also includes a theme topic portion which allows the organization to choose, e.g., from a drop down menu, etc., from different available theme topics for the messages to be used in a social engineering testing campaign. The interface 800 also includes a portion 802 indicating the number of templates in a template inventory that match the selected characterization attributes and/or theme topic. The processor 702 (FIG. 8) is configured to search the template inventory 704 and, based on the selected characterization attributes and theme topics selected, to display the number of templates available matching the selected characterization attributes and theme topics.

With further reference to FIG. 8, based on the selected characterization attributes and theme topics, the processor 702 is configured to select message templates from the template inventory 704, to generate messages based on the selected message templates, and to send the generated messages to selected members 708 of the organizations 706 who may receive and review the messages using electronic devices, e.g., review e-mail, voicemail, telephone calls, social media messages, etc. The processor 702 is configured to track statistics regarding the characterization attributes and theme topics of all messages sent. The processor 702 is configured to monitor engagement with the messages, e.g., monitor whether members of the organizations that received messages respond to the message or take other actions solicited by the message, e.g., click a link to visit a website, enter confidential information, call a telephone number, etc. The processor 702 benchmarks, e.g., maintains statistics, for engagement rate based on characterization attributes and theme topics of messages sent.

In one embodiment, the processor 702 tracks engagement rate, e.g., the ratio of the number of unique members of an organization that engage with a phishing message at least once to the number of total opportunities, e.g., the total number of phishing messages of the type (for example, having specific characterization attributes and theme topics) sent to members of the organization. In one embodiment the processor 702 tracks engagement count, e.g., the number of times that phishing messages are engaged total (for example, the processor 702 counts a single user engaging with a phishing message multiple times, with each engagement being counted as part of the engagement count). Over time, the processor 702 gathers statistics for engagement rate and engagement count for phishing messages with different characterization attributes and different theme topics. The processor 702 is configured to aggregate these statistics to determine a projected engagement rate for different characterization attributes and theme topics.

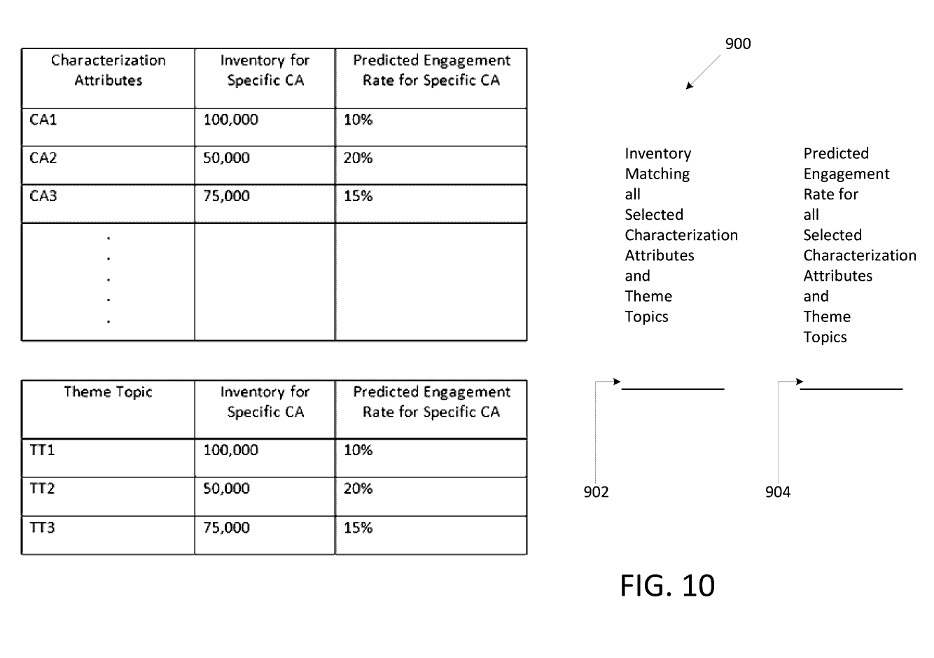

With reference to FIG. 10, an embodiment of a user interface 900, e.g., a graphical user interface, is produced by the processor 702 for display to organizations initiating social engineering testing campaigns. The interface 900 includes a plurality of selectable characterization attributes and theme topics. The interface 900 displays the available inventory of message templates, e.g., number of different message templates, for each characterization attribute and theme topic, e.g., if only that single characterization attribute or theme topic were selected, and the number of message templates available in inventory. Additionally, the interface 900 displays the projected engagement rate for each characterization attribute and theme topic, e.g., if only that single characterization attribute or theme topic were selected, the projected ratio of number of unique members that will engage a phishing message with the selected characterization attribute or theme topic to the total number of phishing messages sent with the selected characterization attribute and theme topic.

In one embodiment, the interface 900 allows organizations to select multiple characterization attributes and/or theme topics. The processor 702 is configured to display in a number display 902 on the interface 900 the number of message templates in the inventory 704 that meet all of the characterization attributes and the theme topic selected by the organization. Additionally, the processor 702 is configured to display in a rate display 904 on the interface 900 a projected engagement rate for phishing messages that match all of the characterization attributes and the theme topic selected by the organization. In one embodiment, the processor 702 is configured to dynamically update both the number display 902 and the rate display 904 as the organization selects or de-selects various characterization attributes and theme topics.

In one embodiment, the projected engagement rates are determined by the processor based on the history of all social engineering testing campaigns run by the processor 702. In another embodiment, the projected engagement rates may be determined by the processor 702 based on a subset of the previous social engineering testing campaigns run by the processor 702. For example, a subset may be selected based on the specific industry of the organization running the campaign, the specific level (e.g., of employee C-suite, entry level, etc.) of the message recipients, the department (e.g., accounting, sales, customer service, etc.) within the organization of the message recipients, etc.

In one embodiment, the processor 702 is configured to receive an indication from the organization of the subsets of campaigns that the organization would prefer to have projected engagement rates displayed for. If the organization chooses a subset for which the information that the processor 702 has available is below a correlation threshold, the processor 702 is configured not to display the projected engagement rates. For example, if the organization chooses to have projected engagement rates limited only to a particular industry, and the processor 702 only has information regarding campaigns for a single other organization in that industry, the processor 702 will not display the projected engagement rates. In another embodiment, if an organization chooses to have projected engagement rates limited to a particular industry, and the processor 702 determines that of the messages previously sent for which the processor 702 has information that the percentage of those messages that are from a single organization is above a threshold, the processor 702 will not display the projected engagement rates. In one embodiment, if an organization chooses to have projected engagement rates limited to a particular industry, the processor 702 will not display the projected engagement rates if there are less than four organizations in the selected industry for which previous social engineering campaign information is available or if any single organization's previous social engineering campaign information constitutes more than 25% of the total data.

In one embodiment, the processor 702 is configured to determine projected engagement rate in several different ways. First, for example, if the processor 702 has sent a total of one million phishing messages having a selected characterization attribute, 900,000 of the messages being sent to members within one organization with a 50% engagement rate, and 100,000 of the messages being sent to members within a second organization with a 10% engagement rate, there are four different engagement rate statistics that may be displayed by the processor 702 to a user. First, a total mean engagement rate can be determined based on the ratio of total number of e-mails engaged to total number of e-mails sent, or 46% in the example above. Second, an average engagement rate can be determined based on the ratio of the sum of the engagement percentages of each organization divided by the total number of organizations, or 30% in the example above. Thus, the processor 702 can display a minimum projected engagement rate, or the lowest engagement rate of any organization for a particular characterization attribute, 10% in the example above. The processor 702 can display a maximum projected engagement rate, or the highest engagement rate of any organization for a particular characterization attribute, 50% in the example above. The processor 702 can display a total mean engagement rate, 46% in the example above. The processor 702 can display an average engagement rate, 30% in the example above.

In one embodiment, the processor 702 is configured to determine for a characterization attribute or combination of characterization attributes the number of phishing messages that must be sent before the projected engagement rate for that characterization attribute or combination of characterization attributes will be statistically significant and/or before the processor 702 will display projected engagement rate for the characterization attribute or combination of characterization attributes. Additionally, in one embodiment, the processor 702 is configured to evaluate characteristics, e.g., job title, organization, department, etc., of recipients of the total number of phishing messages sent for a particular characterization attribute or combination of characterization attributes to ensure that the population has sufficient diversity, randomness, etc., before the projected engagement rate will be displayed.

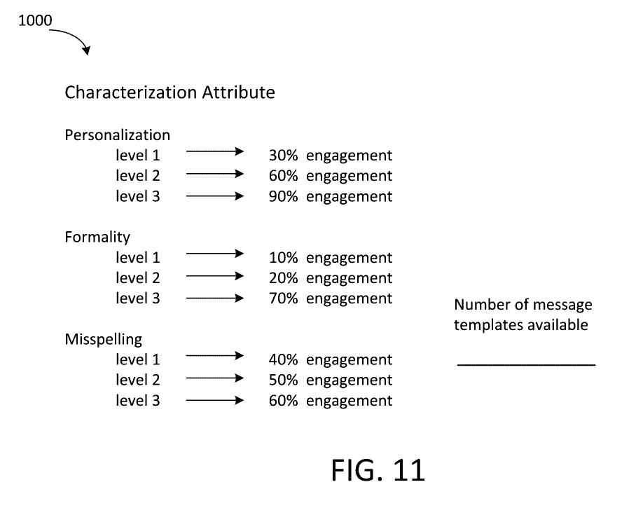

With reference to FIG. 11, an embodiment of an interface shown as a graphical user interface 1000 is illustrated. The interface 1000 is configured to receive input from an organization regarding desired characterization attributes and to display number of templates available in an inventory matching the selected characterization attributes. The interface 1000 is also configured to display projected engagement rate for each level of characterization attributes. Additionally, a processor is configured, upon selection of a characterization attribute, to update the projected engagement rates of the levels of the other characterization attributes. For example, if an organization selects personalization level 1, the processor will update the projected engagement rates for each of the levels of formality and misspelling based on the selected personalization level.

With further reference to FIG. 7, in one embodiment, the processor 702 is configured to calculate and display projected engagement rate for each theme topic independent of characterization attributes selected. In another embodiment, the processor 702 is configured to calculate and display projected engagement rate for each theme topic dependent on the characterization attributes selected. In one embodiment, the processor 702 is configured to calculate and display projected engagement rate for each characterization attribute independent of theme topic selected. In another embodiment, the processor 702 is configured to calculate and display projected engagement rate for each characterization attribute dependent on the theme topic selected.

In one embodiment, upon completion of a social engineering testing campaign, the processor 702 is configured to conduct benchmarking on the results of the social engineering testing campaign and display the results to the organization through the interface. In one embodiment, the processor 702 is configured to indicate whether the actual engagement rate for the organization is within an acceptable engagement rate range. In one embodiment, the processor 702 is configured to indicate to the organization if the actual engagement rate for the organization is above the projected engagement rate. In one embodiment, the processor 702 is configured to display actual engagement rate for a subset of the organization, e.g., by department in the organization, by job title of member of the organization, etc. In other embodiments, the processor 702 is configured to indicate the engagement rate for subsets of the organization based on any attribute associated with a user, including address book attributes and company database attributes. Such user attributes may include risk-based attributes, for example users who have had a virus found on their computer, users who have called the help desk for a password reset or other issues related to computer security, or users who have changed jobs or are new hires, etc.

In one embodiment, a method of generating phishing templates that match the parameters in the Phishing Generation Request is provided.

In one embodiment, a phishing pattern of “{content:greeting} {content:closing}” is provided.

Table 1 illustrates exemplary tags available with the “formality” or “personalization” Characterization Categories applied.

TABLE 1

| | | Characterization | Characterization |
|---|---|---|---|
| | | Category Attributes: | Category Attributes: |
| Tag Type | Tag | Formality | Personalization |
| {content:greeting} | Hi | Formality-1 | Personalization-1 |
| | | Formality-2 | |
| {content:greeting} | Dear | Formality-2 | Personalization-3 |
| | {email:firstName} | Formality-3 | |
| {content:closing} | Sincerely | Formality-2 | Personalization-1 |
| | | Formality-3 | |
| {content:closing} | Thanks | Formality-1 | Personalization-1 |

In one example, the system is configured to randomly create 4 different Phishing Templates based on having 2 of each of greetings and closings. Table 2 illustrates exemplary possible combinations.

TABLE 2
Phishing Pattern Universe

| Phishing Template based on | | |
|---|---|---|
| Phishing Pattern | | |
| {content:greeting} | Characterization Category | Characterization Category |
| {content:closing} | Attributes: Formality | Attributes: Personalization |
| Hi Sincerely | Formality-1 | Personalization-1 |
| | Formality-2 | Personalization-1 |
| | Formality-3 | |
| Hi Thanks | Formality-1 | Personalization-1 |
| | Formality-2 | |
| Dear {email:firstName} | Formality-2 | Personalization-3 |
| Sincerely | Formality-3 | |
| Dear {email:firstName} | Formality-1 | Personalization-1 |
| Thanks | Formality-2 | Personalization-3 |
| | Formality-3 | |

In one embodiment, the system is configured to receive an input from a user indicating the formality desired by the user. If the user indicates that they only want to generate a Phishing Template that includes Formality-1 content then no combinations would be available.

If the user indicates that they only want phishing templates with a Personalization of 3, then the system would randomly provide the user with one of two templates, such as “Dear {email:firstName} Sincerely” and “Dear {emailFirstName} Thanks”.

In one embodiment, the system is configured to similarly receive input from the user regarding desired themes.

In some embodiment, the system may be configured to receive characterization attributes input from users in one of the following exemplary ways.
1. Inclusive—only include Formality-1 but not Formality-2 or Formality-3.
2. Exclusive—only include anything that is NOT Formality-3.
3. Specific—only include Formality-1 or Formality-3.

In one embodiment, the system and/or method for selecting Attributes and Themes is interactive.

In one embodiment, a method for generating messages from a pre-built table is provided. For example, the method may include exhaustively listing the Phishing Pattern Universe in a table.

In one embodiment, the method includes running random queries to filter the available Attributes of the Phishing Templates.

For example, consider where there are 3 Tag Types within a single Phishing Pattern. 3 Greetings, 3 Pretexts, 3 Closings, there would be 3*3*3=27 entries (i.e., combinatorial possibilities) in the table.

In another example, 100 of each tag type are provided in a pattern. The table in this example would include 100*100*100=1,000,000 entries.

In another example, four Tag Types are provided, where tag type 1 includes 4 options; tag type 2 includes 6 options; tag type 3 includes 10 options; and tag type 4 includes 5 options. The table in this example would include 4*6*10*5=1200 entries.

In various embodiments, any number of tags type and any number of tags per tag type may be used. In typical embodiments, 5-10 tag types, 10-20 tag types, 20-50 tag types, or more than 50 tag types may be used.

In one embodiment, a method for generating messages on-the-fly is provided. A Phishing Template from a Phishing Pattern Universe may be created on-the-fly as follows.
1. User specifies one or more of each Phishing Patterns, Characterization Attributes and Themes.
2. The system looks at the Phishing Pattern to select the each Tag Type.
3. For the each Tag Type, the system randomly chooses a Tag of that Type that matches the Characterization Attributes and Themes. For example, the system may choose a theme that “Animals Need Your Help” and a Personalization Level of 1.
4. If there is no Tag that matches the existing Characterization Attributes and Themes, then the system may choose replacements based on user defined behavior. For example, if there is no Greeting of Personalization-1, the system could be configured to allow, or disallow the selection of Personalization-2 Tags.
5. While generating a particular Phishing Template, the system will keep track of the choices made. If a user showed no preference for Formality level, and the system chooses the “Dear {email:firstName}” greeting, it will have a strong preference to choose future tags, such as the closing “Sincerely” to help create a coherent message. In a similar manner, once a Theme is chosen for a message, the system will attempt to pick tags that are an exact match, or a generic Theme. Thus continuity of characteristics between Pretext and Call to Action may be maintained.

In one embodiment, the system creates different Phishing Templates based on the user-specified Phishing Patterns, Characterization Attributes and Themes.

In one embodiment, the system can generate millions of possible unique email templates on-the-fly, while keeping them coherent. The attributes of each generated Phishing Template is used to generate each Phish. Therefore, the system is configured to benchmark and report on variations.

In one embodiment, themes are specified.

In one embodiment, benchmark data is available within the user interface for the user who is selecting Phishing Patterns, Characterization Attributes and Themes.

In one embodiment, the benchmark shows information about the number of possible Phishing Templates that could be generated based on the Phishing Patterns, Tags, etc.

In another embodiment, benchmarking information is provided regarding the “track record” of various phishing test attributes, such as click-through-rate, out of office reply, call-back rate, etc.

In another embodiment, benchmarks are put in the context of industry-specific statistics. In another embodiment, benchmarks are compared to other available database information from prior campaigns at this customer site or across customers.

In one embodiment, a system is provided that is configured to select templates and themes at will, e.g., without any themes or characteristics being received from a user.

In one embodiment, the system is configured to inquire from the user whether to apply the spell-wrecker function, grammar-wrecker function, and wrecker-protector function, to receive user input regarding applying these functions, and to apply these functions based on user input.

In one embodiment, the system is configured to receive input from the user regarding Campaign Profiles for use in customizing the generated Phishing Templates.

In one embodiment, the system is configured to all a user to apply Campaign Profiles to a phishing template created, for example, by the user, not by the system, etc.

In one embodiment, the system provides the ability to apply Themes and Characterization Attributes to Campaign Profiles.

In various embodiments, Campaign Profiles are different than Tags, e.g., the user is able to provide information in the Campaign Profile. In one embodiment, the user does not develop Tags.

In various embodiments, graphical user interfaces described herein may be configured to be displayed, e.g., displayed on computer screens, electronic device screens, etc.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

In various embodiments, systems, processors, modules, interfaces, and message generators described herein may include a general purpose processor, an application specific processor, a circuit containing one or more processing components, a group of distributed processing components, e.g., distributed computers configured for processing, etc. Embodiments of systems, processors, modules, interfaces, and message generators may be or include any number of components for conducting data processing and/or signal processing. According to an exemplary embodiment, any distributed and/or local memory device may be utilized with and/or included in the systems, processors, modules, interfaces, and message generators of this disclosure. In one embodiment, systems, processors, modules, interfaces, and message generators may include memory communicably connected to the systems, processors, interfaces and message generators (e.g., via a circuit or other connection) and may include computer code for executing one or more processes described herein.

In various embodiments, the systems, processors, modules, interfaces, and message generators may be implemented in software. In another embodiment, the systems, processors, modules, interfaces, and message generators may be implemented in a combination of computer hardware and software. In various embodiments, systems implementing systems, processors, modules, interfaces, and message generators discussed herein include one or more processing components, one or more computer memory components, and one or more communication components. In various embodiments, the systems, processors, modules, interfaces, and message generators may include a general purpose processor, an application specific processor (ASIC), a circuit containing one or more processing components, a group of distributed processing components, a group of distributed computers configured for processing, etc., configured to provide the functionality discussed herein. In various embodiments, the systems, processors, modules, interfaces, and message generators may include memory components such as one or more devices for storing data and/or computer code for completing and/or facilitating the various processes described in the present disclosure, and may include database components, object code components, script components, and/or any other type of information structure for supporting the various activities described in the present disclosure. In various embodiments, the communication components described herein may include hardware and software for communicating data for the system and methods discussed herein. For example, communication components may include, wires, jacks, interfaces, wireless communications hardware etc., for receiving and transmitting information as discussed herein. In various specific embodiments, the systems, processors, interfaces, and message generators and/or methods described herein, may be embodied in nontransitory, computer readable media, including instructions (e.g., computer coded) for providing the various functions and performing the various steps discussed herein. In various embodiments, the computer code may include object code, program code, compiled code, script code, executable code, instructions, programmed instructions, non-transitory programmed instructions, or any combination thereof. In other embodiments, systems, processors, modules, interfaces, and message generators described herein may be implemented by any other suitable method or mechanism.

What is claimed is:

1. A system for testing the susceptibility of an organization to social engineering comprising:
an interface configured to receive input from a user selecting characterization attributes for message templates for a social engineering testing campaign;
a processor configured to receive the input through the interface;
a message template inventory containing a plurality of message templates, each of the templates having characterization attributes; and
wherein the processor is configured to select message templates from the plurality of message templates consistent with the characterization attributes selected by the user.

2. The system of claim 1, wherein the processor is configured to create messages based on the selected message templates, the messages soliciting an action from a plurality of message recipients, the plurality of message recipients being members of the organization, to send the messages to the plurality of message recipients, and to monitor whether each of the plurality of message recipients take the solicited action.

3. The system of claim 2, wherein the processor is configured to determine an engagement rate based on whether the plurality of message recipients take the solicited action and the total number of messages sent.

4. The system of claim 3, wherein the processor is configured to determine a projected engagement rate based on the selected characterization attributes.

5. The system of claim 4, wherein the processor is configured to display the projected engagement rate to the user through the interface if the information upon which the projected engagement rate is based is above a correlation threshold.

6. The system of claim 5, wherein the processor is configured to display to the user through the interface the determined engagement rate and the projected engagement rate.

7. The system of claim 6, wherein the interface is configured to receive input from the user directing filtering of the engagement rate to an engagement rate of a subset of recipients of messages.

8. The system of claim 7, wherein the subset of recipients of messages is determined based on at least one of a department within the organization of which the recipients are members and job titles of recipients of messages.

9. The system of claim 6, wherein the interface is configured to receive input from the user directing filter of the projected engagement rate to an engagement rate of a particular industry.

10. The system of claim 1, wherein the system is configured to display the number of the selected message templates through the interface to the user.

11. A system for generating a plurality of phishing templates for testing the susceptibility of an organization to social engineering comprising:
an interface configured to receive input from a user selecting one or more phishing patterns, one or more characterization attributes, and one or more themes;
a processor configured to receive the input through the interface;
wherein the processor is configured to generate a plurality of phishing templates by identifying each of the tag types present in the phishing pattern, and for each identified tag type matching the tag type to the user-selected characterization attributes and themes, and replacing the tag type present in the phishing pattern with a tag content in the phishing template, wherein the tag content is consistent with the user-selected characterization attributes and themes, and wherein the tag content is further consistent with each tag content in the phishing template.

12. The system of claim 11, wherein the system is configured to display the number of the generated plurality of phishing templates through the interface to the user.

13. The system of claim 11, wherein the system is configured to generate a plurality phishing messages from the plurality of phishing templates.

14. The system of claim 11, wherein the system is configured to choose replacement tag content based on a user defined behavior.

15. A method of testing the susceptibility of an organization to social engineering comprising:
compiling projected engagement rate statistics for message templates based on characterization attributes;
displaying projected engagement rate statistics for messages based on characterization attributes;
receiving desired characterization attributes for a social engineering testing campaign from the organization;
selecting message templates from a message template inventory based on received desired characterization attributes;
producing phishing messages based on the selected message templates;
sending the phishing messages to members of the organization;
monitoring actual engagement rate for the phishing messages sent to the members of the organization; and
displaying the actual engagement rate to the organization.
